(19) United States
(12) Patent Application Publication
(10) Pub. No.: US 2025/0189688 A1
(43) Pub. Date: Jun. 12, 2025

(54) SYSTEM AND METHOD FOR TIME-LAPSE SEISMIC ACQUISITION AND PROCESSING

(71) Applicants: Xinding Fang, Sugar Land, TX (US); Siwei Li, Katy, TX (US); Tianrun Chen, Houston, TX (US)

(72) Inventors: Xinding Fang, Sugar Land, TX (US); Siwei Li, Katy, TX (US); Tianrun Chen, Houston, TX (US)

(21) Appl. No.: 19/047,547

(22) Filed: Feb. 6, 2025

Related U.S. Application Data
(60) Provisional application No. 63/716,855, filed on Nov. 6, 2024.

(51) Int. Cl. G01V 1/30

(52) U.S. Cl. CPC G01V 1/308; G01V 2210/66

(57) ABSTRACT

A system and method for time-lapse seismic data acquisition and processing using permanent or semi-permanent seismic sources, combined with a specialized processing workflow. The method is designed to reliably detect time-lapse changes in the structure and physical properties of subsurface formations over time by providing highly repeatable seismic surveys. This method includes optimizing the seismic source system based on the specific environment to determine the ideal sweep setups; establishing an efficient sweep schedule to maximize data quality while minimizing operational costs; creating a baseline seismic model by capturing seismic data over a predetermined time frame prior to production activities; and continuously acquiring and comparing time-lapse seismic data with the baseline to detect variations in seismic attributes that reflect structural or physical property changes in subsurface formations.

### CROSS REFERENCE TO RELATED APPLICATIONS

This application claims priority from a U.S. Provisional Patent Appl. No. 63/716,855, filed on Nov. 6, 2024, which is incorporated herein by reference in its entirety.

### FIELD OF INVENTION

The present invention relates to a system and method for time-lapse seismic data acquisition and processing, and more specifically, the present invention relates to the High-Repeatability 4D Time-Lapse Seismic Acquisition and Processing Technique.

### BACKGROUND

Seismic acquisition systems typically consist of seismic sources and seismic receivers. A seismic source, such as vibroseis truck, hydraulic or electric vibrator, and weight drop system is a device that generates controlled seismic energy, producing seismic waves that travel through a medium. A seismic source may emit single pulses or continuous sweeps of energy. Seismic receivers, such as geophones, hydrophones, and accelerometers detect and record seismic waves that are reflected or refracted from underground layers. The technique of seismic surveys i.e., the technique of using the seismic acquisition systems plays a critical role in collecting and analysis of data. Seismic surveys are done for a variety of purposes, such as oil & gas exploration & production, CO₂ sequestration, geothermal exploration, and subsurface characterization for civil engineering projects.

A time-lapse seismic survey, also known as a 4-D seismic survey, is a geophysical technique used to monitor changes in a subsurface over time. It involves acquiring and comparing multiple seismic surveys of the same area at different time intervals to detect and analyze variations in the structure and physical properties of the subsurface formations. Ensuring the repeatability of these surveys is essential for obtaining reliable information about time-lapse changes in monitored formations.

A seismic source must maintain strong and consistent coupling with the ground in order to ensure efficient transmission of the source's energy into the earth and produce repeatable seismic data. For surface seismic sources, a common method to achieve coupling involves placing a heavy weight on a flat plate, which is then subjected to vibrations. This technique is widely used in surface seismic surveys for oil and gas exploration. However, the repeatability of such a process for the time-lapse seismic surveys is less reliable, as the surface coupling can change over time. Additionally, this method requires heavy and expensive seismic equipment (e.g., vibroseis trucks), making it unsuitable for cost-sensitive applications like CO₂ sequestration monitoring.

Other methods to achieve good coupling are to bury or cement the source underground or install it within an existing wellbore. However, burying or cementing a source is time-consuming, expensive, and infeasible to relocate or repair. While downhole installation can provide efficient energy transmission, it is only suitable for small power sources, as the source size is limited by the wellbore diameter.

An alternative approach is to use an anchoring system, such as a concrete pillar, helical pile, or helical anchor, rigidly mounting the source on top of the anchor at the surface. This method ensures strong coupling with the earth while allowing the source to remain accessible for maintenance and relocation. Consequently, anchoring systems are preferable for constructing permanent or semi-permanent seismic sources, particularly for long-term time-lapse seismic surveys.

While a good anchoring system can ensure a strong coupling of a seismic source with the earth, improvements in achieving optimal repeatability for time-lapse seismic surveys are desired for a long time.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a reliable and cost-effective system and method to detect time-lapse changes in the structure and physical properties of subsurface formations over time by providing highly repeatable seismic surveys.

Another object of the present invention is to provide improved operation and acquisition strategies and dedicated processing workflows.

Another object of the present invention is that the system and method are reliable and cost-effective.

Another object of the present invention is that the system has improved seismic survey Repeatability.

Still, another object of the present invention is that the quality of seismic data collected can be enhanced.

A further object of the present invention is that the operational efficiency can be improved.

An additional object of the present invention is that accurate time-lapse monitoring can be achieved.

In one aspect, the disclosed are a system and method for 4-D Time-Lapse Seismic Acquisition and Processing Technique. The system and method provide a robust and efficient method for monitoring subsurface changes over time. By combining optimized seismic source tuning, advanced sweep scheduling, dedicated processing workflow, and a comprehensive baseline monitoring process, the disclosed method improves the accuracy and repeatability of time-lapse seismic surveys, making it a valuable tool for subsurface monitoring in a variety of applications.

In one aspect, disclosed are a system and method that integrate an anchored source system with dedicated acquisition strategies and processing workflows. This integration ensures highly repeatable time-lapse seismic surveys, enabling accurate detection of changes in subsurface formations' structure and physical properties over time.

In one aspect, disclosed is a method for time-lapse seismic data acquisition and processing using highly repeatable seismic surveys, the method includes mounting a vibrator source to an anchoring system, wherein the vibrator source is configured to generate custom linear or nonlinear sweep signals, the anchoring system comprises an anchoring base; installing a source monitoring seismic sensor adjacent to the anchoring base, wherein the source monitoring seismic sensor is configured for recording source sweep waveforms; mounting one or more de-ghost sensors on a surface near the vibrator source, wherein the one or more de-ghost sensors are configured to record seismic waveforms at the surface above the source monitoring seismic sensor; and coupling the source monitoring seismic sensor and the one or more de-ghost sensors to a source monitoring seismic control and communication box.

In one aspect, the source monitoring seismic sensor is positioned at a depth comparable to a depth of the anchoring base from the surface. The source monitoring seismic sensor and the anchoring base are separated by a predefined distance.

In one aspect, the method further comprises deploying an array of seismic receivers for recording reflected and refracted seismic waves. The method further comprises optimizing the vibrator source based on a specific environment to determine ideal sweep setups; and establishing a sweep schedule to maximize data quality. The method further comprises creating a baseline seismic model by capturing seismic data over a predetermined timeframe. The method further comprises acquiring time-lapse seismic data through the array of seismic receivers; and comparing the time-lapse seismic data against the baseline seismic model to detect variations in seismic attributes. The method further comprises enabling an identification of structural or physical changes within subsurface formations by analyzing the variations in seismic attributes.

In one aspect, the source monitoring seismic sensor is mechanically decoupled from the anchoring system.

In one aspect, the method further comprises recording, by the source monitoring seismic sensor, the source sweep waveforms; and enabling de-ghosting of seismic signals using the source sweep waveforms for improving a resolution of seismic data. The method further comprises conducting repeated seismic sweeps on a predetermined schedule to generate raw common receiver gathers for each receiver of the array of seismic receivers; removing source response from individual seismic traces through deconvolution, using corresponding source sweep waveform recorded by the source monitoring seismic sensor; removing surface ghost reflections from the individual seismic traces through de-ghosting using corresponding seismic data recorded by the one or more de-ghost sensors; creating a 3D data volume in sweep-offset-time domain by consolidating the deconvolved and de-ghosted common receiver gathers from all receivers; extracting coherent seismic signals using pattern recognition techniques and filtering out incoherent surface noise; stacking coherent data from all sweeps to form a shot gather, which serves as a baseline reference for a specific date; and recording local weather data for the specific date.

In one aspect, the method further comprises consolidating daily shot gathers over a predefined duration to capture seismic response under varying seasonal and weather conditions; extracting characteristics of surface waves, shallow reflected/refracted waves, and deep reflections below a target layer as functions of date and weather conditions; processing the characteristics together with the local weather data to form a formation seasonal fingerprint library, wherein the formation seasonal fingerprint library represents a natural seismic response variation in a monitored area under different weather conditions.

In one aspect, the step of comparing the time-lapse seismic data against the baseline seismic model comprises processing current shot gather data from time-lapse seismic surveys to extract its current fingerprint; comparing the current fingerprint with the formation seasonal fingerprint library to identify a shot gather from a same time period with similar weather conditions; and using a matched baseline shot gather as a reference to assessing time-lapse changes in the seismic response of a target monitoring layer, ensuring that comparisons account for natural seasonal variations and identifying changes due to subsurface operations.

In one aspect, disclosed is a system for time-lapse seismic data acquisition and processing using highly repeatable seismic surveys, the system comprises a vibrator source configured to be mounted to an anchoring system, wherein the vibrator source is configured to generate custom linear or nonlinear sweep signals, the anchoring system comprises an anchoring base; a source monitoring seismic sensor configured to be installed adjacent to the anchoring base, wherein the source monitoring seismic sensor is configured for recording source sweep waveforms; one or more de-ghost sensors configured to be mounted on a surface near the vibrator source, wherein the one or more de-ghost sensors are configured to record seismic waveforms at the surface above the source monitoring seismic sensor; and a source monitoring seismic control and communication box coupling the source monitoring seismic sensor and the one or more de-ghost sensors.

In one aspect, disclosed is a method for time-lapse seismic data acquisition and processing using highly repeatable seismic surveys, the method comprises optimizing a seismic source system based on a specific environment to determine ideal sweep setups; establishing an efficient sweep schedule to maximize data quality; creating a baseline seismic model by capturing seismic data over a predetermined period; and continuously acquiring and comparing time-lapse seismic data with the baseline seismic model to detect variations in seismic attributes that reflect structural or physical property changes in subsurface formations.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a schematic of seismic data acquisition, according to an exemplary embodiment of the present invention.

FIG. 2 is a flowchart illustrating the 4-D time-lapse seismic monitoring process, according to an exemplary embodiment of the present invention.

FIG. 3 is a flowchart illustrating the seismic system in-situ tuning and sweep scheduling procedures, according to an exemplary embodiment of the present invention.

FIG. 4 is a flowchart illustrating a procedure of processing pre-production baseline monitoring, according to an exemplary embodiment of the present invention.

FIG. 5 is a flowchart illustrating a procedure of production time-lapse monitoring processing, according to an exemplary embodiment of the present invention.

FIG. 6 illustrates an example of a source sweep waveform, characterized by three key parameters including acceleration time, deceleration time, and peak frequency, according to an exemplary embodiment of the present invention.

FIG. 7 displays a data example of the source stabilization process, according to an exemplary embodiment of the present invention.

FIG. 8 presents an example of a 3D data volume in the sweep-offset-time domain, according to an exemplary embodiment of the present invention.

FIG. 9 illustrates an example of a shot gather constructed by stacking coherent signals extracted from the data in the sweep-offset-time domain, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The invention described herein pertains to a system and method for time-lapse seismic data acquisition and processing using permanent or semi-permanent seismic sources mounted on anchoring systems, combined with a specialized processing workflow. The disclosed system and method are designed to reliably detect time-lapse changes in the structure and physical properties of subsurface formations over time by providing highly repeatable seismic surveys. This method includes optimizing the seismic source system based on the specific environment to determine the ideal sweep setups; establishing an efficient sweep schedule to maximize data quality while minimizing operational costs; creating a baseline seismic model by capturing seismic data over a predetermined time frame prior to production activities; and continuously acquiring and comparing time-lapse seismic data with the baseline to detect variations in seismic attributes that reflect structural or physical property changes in subsurface formations.

Disclosed are a system and method for High-Repeatability 4-D Time-Lapse Seismic Acquisition and Processing Technique. 4-D time-lapse seismic monitoring refers to the repeated use of seismic methods to detect changes in subsurface formations before and after operational activities such as fluid or gas injection or extraction. The success of 4D monitoring depends on highly repeatable seismic surveys, ensuring accurate detection of subsurface changes independent of surface conditions. The disclosed system and method provide for high repeatability of seismic surveys. The use of permanent or semi-permanent seismic sources installed on anchoring systems, combined with in-situ tuning and optimized sweep scheduling, improves the repeatability of seismic surveys.

The disclosed system also provides enhanced data quality. Dedicated deconvolution and de-ghosting techniques combined with specialized noise suppression and signal extraction techniques in the sweep-offset-time domain enhance seismic data's signal-to-noise ratio and resolution, providing a clearer delineation of subsurface changes. Also, operational efficiency can be improved by optimizing the sweep schedule and using advanced processing techniques. This method reduces operational costs while maintaining high-quality data acquisition. Also, the system and method may provide for accurate time-lapse monitoring. The inclusion of a Formation Seasonal Fingerprint Library may ensure that natural variations in seismic responses can be accounted for, enabling accurate detection of changes caused by production activities.

The disclosed system may include seismic sources and seismic receivers. The seismic sources may include vibrators mounted on anchoring systems. Seismic sources may be programmed to generate custom linear or nonlinear sweep signals. These sweep signals may travel to a medium for conducting seismic surveys. The anchoring systems may include helical anchors, concrete pillars, suitable underground structures, and the like. Also, downhole sources may be deployed within pipes. Seismic receivers may include single-component or multi-component acceleration, velocity, or strain sensors, or Distributed Acoustic Sensing (DAS) fiber sensors. It is to be noted that embodiments provide specific examples of the Seismic sources and Seismic receivers, however, any other types of suitable Seismic sources and seismic receivers are within the scope of the present invention.

The Seismic receivers, according to the present invention, may be deployed on the surface, buried underground, and/or placed inside wells. The recorded seismic data can be processed to extract information about the subsurface structures and their physical properties.

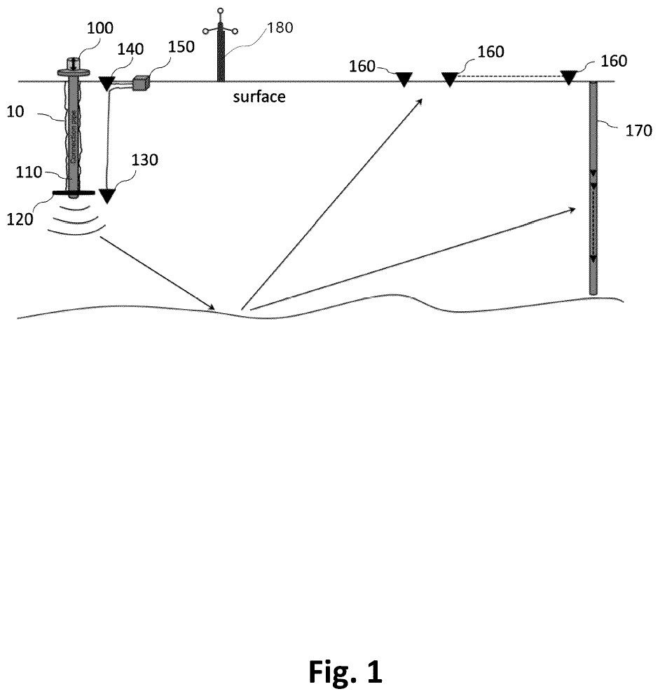

Referring to FIG. 1 illustrates a schematic of seismic data acquisition according to an exemplary embodiment of the present invention. Seismic data acquisition, according to the present invention, may use a permanent or semi-permanent vibrator source with both surface and downhole seismic arrays. FIG. 1 shows a dark linear line representing a surface and borehole wall 10 extending downwards from the surface. A vibrator source 100, either permanent or semi-permanent, may be mounted on an anchoring system. The anchoring system may be a connection pipe 110 and an anchoring base 120. It is to be noted that the vibrator source may be mounted directly to the anchoring base, and any such variation is within the scope of the present invention. The anchoring system may transmit vibrational energy into the earth through the anchoring base 120.

A source monitoring seismic sensor 130 may be positioned adjacent to the anchoring base 120 to record the source waveforms. The source monitoring seismic sensor 130 may be placed at a depth comparable to that of the anchoring base 120 and preferably within a short distance (e.g., tens of meters) from the vibrator source 100. However, it should not be placed too close to the anchoring base, with a minimum recommended distance of at least 0.5 meters. The source monitoring seismic sensor 130 could be influenced by the nonlinear inelastic response of the soil surrounding the anchoring base 120 if it is positioned too close to the source. The recorded source waveforms might be impacted by the radiation pattern of the source anchoring system if the source monitoring seismic sensor 130 is positioned too far away from the source. Therefore, to ensure accurate measurements of the source waveforms, the source monitoring seismic sensor 130 should be positioned within an optimal range, typically a radius of 0.5 to 10 meters from the anchoring base 120.

The source monitoring seismic sensor 130 may monitor the source waveforms. One or more de-ghost sensors 140 may be installed on the surface near the vibrator source 100 to record the seismic waveforms at the surface above the source monitoring seismic sensor 130. Source de-ghosting is a process to improve the seismic data's resolution by removing the reflection of the source signals at the surface. The difference between the waveforms recorded at the source monitoring seismic sensor 130 and the de-ghost sensors 140 is used to estimate the propagation time of the seismic waves from the anchoring base 120 to the surface, which is then further used to eliminate the surface reflection from the recorded data. A source monitoring seismic control and communication box 150 is connected to the source monitoring seismic sensor 130 and the one or more de-ghost sensors 140 to acquire their recorded seismic data. FIG. 1 also shows an array of surface seismic receivers 160 and downhole seismic receivers 170 for recording the reflected and refracted seismic waves. Additionally, FIG. 1 shows a weather station 180 for recording the local weather data, including temperature, precipitation, humidity, wind speed and direction, atmospheric pressure, etc.

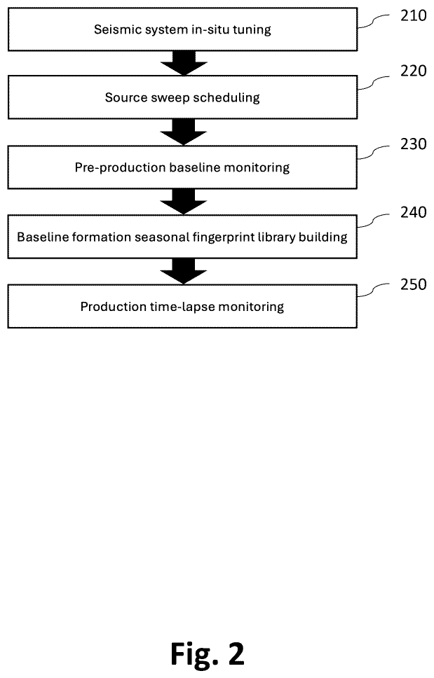

Referring to FIG. 2 which illustrates the 4-D time-lapse seismic monitoring process. First, the process may include seismic System In-Situ Tuning, at step 210. The step includes optimizing the seismic source system, such as the vibrator source 100 in FIG. 1, based on the specific environment to determine the ideal sweep setups. Thereafter, establishing an efficient sweep schedule to maximize data quality while minimizing operational costs, at step 220. Pre-production baseline monitoring, at step 230 includes creating a baseline seismic model by capturing seismic data over a predetermined timeframe prior to production activities. Subsequently, the baseline formation seasonal fingerprint library building, at step 240 includes compiling the baseline seismic features extracted from the data recorded under varying seasonal and weather conditions. Then, production time-lapse monitoring, at step 250 which includes continuously acquiring and comparing time-lapse seismic data against the baseline model to detect variations in seismic attributes, enabling the identification of structural or physical changes within subsurface formations.

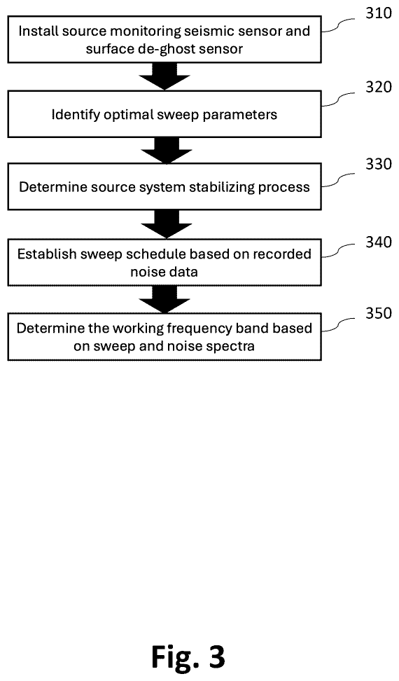

The steps 210 and 220 of optimizing the seismic sources in 4-D seismic monitoring and source sweep scheduling are further explained in FIG. 3. The process of optimizing the seismic sources in 4-D seismic monitoring includes installing a source monitoring seismic sensor and surface de-ghost sensor, at step 310. At least one source waveform monitoring seismic sensor may be installed within a recommended range of 0.5˜10 meters radius of the seismic source to record the source sweep waveform. The source waveform monitoring seismic sensor may be mechanically decoupled from the source anchoring system and positioned at a depth similar to the seismic source anchoring base, as shown in FIG. 1. At least one source de-ghost seismic sensor can be installed at the surface and aligned vertically with the source monitoring seismic sensor. At least one source de-ghost seismic sensor may record the source sweep waveforms at the surface and enable de-ghosting (removal of the reflections from the free surface) of the seismic signals to improve seismic data resolution.

The process of optimizing the seismic sources in 4-D seismic monitoring includes identifying optimal sweep parameters, at step 320 and determining the source system stabilization process, at step 330. The system may use the data recorded by the source monitoring seismic sensor as the source waveform for deconvolution, differing from traditional surface seismic surveys that use synthetic source waveforms. The system may characterize the source sweep by its acceleration time, deceleration time, and peak frequency, with acceleration and deceleration being linear or nonlinear. The system can identify the resonance frequency inherent to the mechanical structure of the seismic source system and operate below this resonance frequency to avoid excessive vibrations that could damage the system or reduce sweep repeatability. The system can employ a grid search to identify the optimal combination of sweep parameters (acceleration, deceleration, peak frequency) for generating the strongest, most stable seismic sweep. Thereafter, the system can stabilize the seismic source system by progressively increasing the vibration strength beyond the designed peak strength and then reducing it to normal operational levels. This stabilization decouples the pipe or pole from borehole friction and compacts the soil around the anchoring base, optimizing energy transmission. Stabilization is considered complete when recorded signals stabilize.

The method for scheduling seismic sweeps to optimize data quality while minimizing cost, at step 220, may include establishing a sweep schedule based on recorded noise data, at step 340 and determining the working frequency band based on sweep and noise spectra, at step 350. The system may conduct seismic sweeps over 24 hours during the in-situ tuning process, potentially extending over weeks or months. The system can monitor ambient noise variations and identify background noise sources to determine the optimal time window for sweeps. The system can adjust the number of sweeps per run and the interval between sweeps to achieve the desired signal-to-noise ratio and source repeatability. The system can define a working frequency band between the identified sweep cutoff frequency (where background noise strength exceeds sweep signals) and the sweep peak frequency, and processing data within this frequency band.

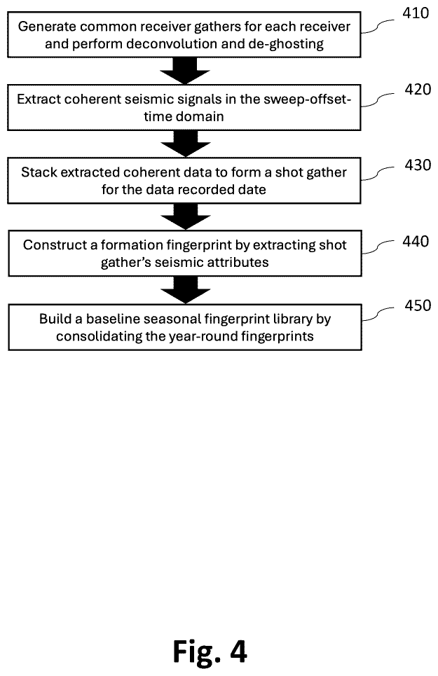

The method, in step 230, for establishing a baseline model prior to production is further illustrated in FIG. 4. The method includes generating common receiver gathers for each receiver and performing deconvolution and de-ghosting, at step 410; extracting coherent seismic signals in the sweep-offset-time domain, at step 420; stacking extracted coherent data to form a shot gather for the data recorded date, at step 430; constructing a formation fingerprint by extracting shot gather's seismic attributes, at step 440; and building a baseline seasonal fingerprint library by consolidating the year-round fingerprints, at step 450.

The system can conduct repeated seismic sweeps on a consistent schedule (daily, weekly, or monthly) to generate raw common receiver gathers for each receiver. Thereafter, remove the source response from individual seismic traces through deconvolution, using the corresponding source waveforms recorded by the source monitoring sensor. The system can remove surface ghost reflections from individual seismic traces through de-ghosting using the corresponding seismic data recorded by the source de-ghost sensor. The system can create a 3D data volume in the sweep-offset-time domain by consolidating the deconvolved and de-ghosted common receiver gathers from all receivers. Then extracting coherent seismic signals using pattern recognition techniques, filtering out incoherent surface noise, and stacking coherent data from all sweeps to form a shot gather, which serves as a baseline reference for the specific date.

The method, at step 240, for creating a comprehensive baseline model of formation seismic response includes consolidating daily shot gathers over a year to capture the seismic response under varying seasonal and weather conditions (i.e., temperature, precipitation, humidity, wind speed and direction, and atmospheric pressure recorded by the local weather station), extracting characteristics of surface waves, shallow reflected/refracted waves, and deep reflections below the target layer as functions of date and weather conditions; and compiling these features to form a Formation Seasonal Fingerprint Library, representing the natural seismic response variations of the monitored area under different weather conditions.

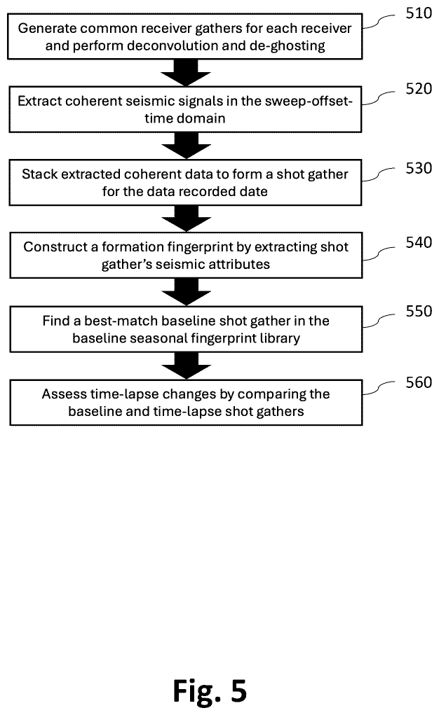

The method, in step 250, for comparing time-lapse seismic data with baseline data is further illustrated in FIG. 5. The method includes generating common receiver gathers for each receiver and performing deconvolution and de-ghosting, at step 510; extracting coherent seismic signals in the sweep-offset-time domain, at step 520; stacking extracted coherent data to form a shot gather for the data recorded date, at step 530; constructing a formation fingerprint by extracting shot gather's seismic attributes, at step 540; finding a best-match baseline shot gather in the baseline seasonal fingerprint library, at step 550; and assess time-lapse changes by comparing the baseline and time-lapse shot gathers, at step 560.

For comparing time-lapse seismic data with baseline data, the system can process current shot gather data from time-lapse seismic surveys to extract its current fingerprint; compare the current fingerprint with the baseline Formation Seasonal Fingerprint Library to identify a shot gather from the same time period with similar weather conditions; and using the matched baseline shot gather as a reference to assess time-lapse changes in the seismic response of the target monitoring layer, ensure that comparisons account for natural seasonal variations and identifying changes due to subsurface operations such as injection or extraction.

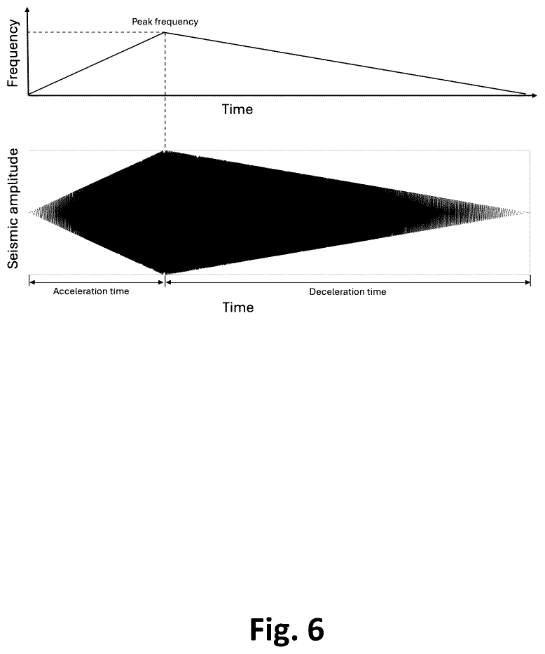

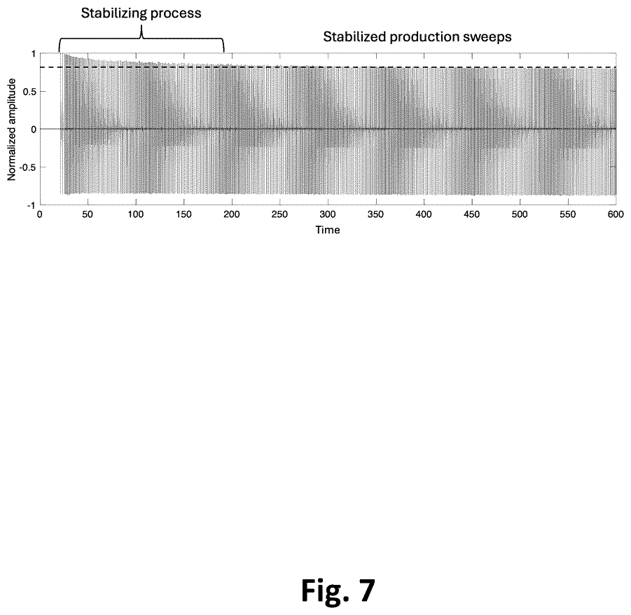

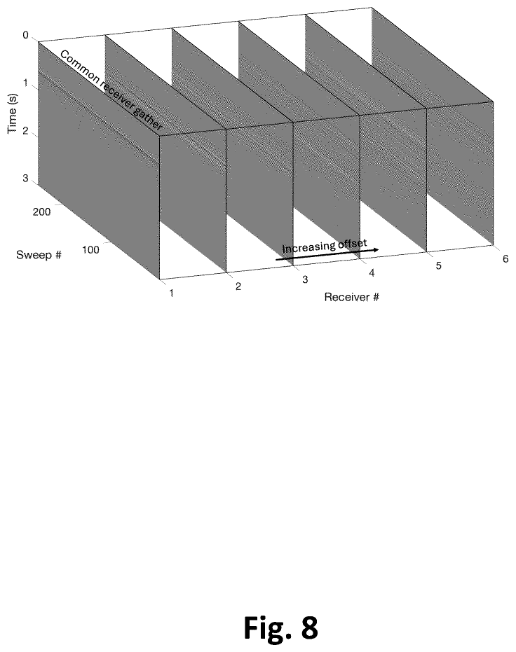

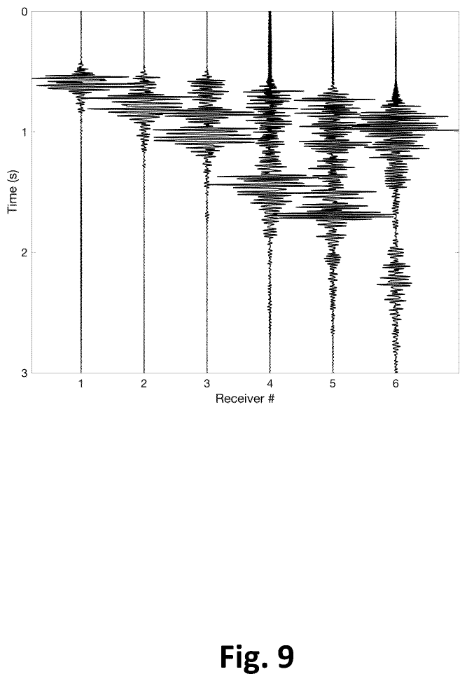

Referring to FIG. 6 illustrates an example of a source sweep waveform, characterized by three key parameters including acceleration time, deceleration time, and peak frequency. FIG. 7 displays a data example illustrating the source stabilization process. In this process, the source vibration strength is gradually increased beyond the designed peak strength and subsequently reduced to normal operational levels. Stabilization is deemed complete once the strength of the recorded signals reaches a consistent level. FIG. 8 presents an example of a 3D data volume in the sweep-offset-time domain. Each 2D slice, recorded at an individual receiver (or offset), represents a common receiver gather composed of seismic traces for a single receiver generated by multiple sweeps conducted during a single acquisition run. FIG. 9 illustrates an example of a shot gather constructed by stacking coherent signals extracted from the data in the sweep-offset-time domain.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for time-lapse seismic data acquisition and processing using highly repeatable seismic surveys, the method comprises:
mounting a vibrator source to an anchoring system, wherein the vibrator source is configured to generate custom linear or nonlinear sweep signals, the anchoring system comprises an anchoring base;
installing a source monitoring seismic sensor adjacent to the anchoring base, wherein the source monitoring seismic sensor is configured for recording source sweep waveforms;
mounting one or more de-ghost sensors on a surface near the vibrator source, wherein the one or more de-ghost sensors are configured to record seismic waveforms at the surface above the source monitoring seismic sensor; and
coupling the source monitoring seismic sensor and the one or more de-ghost sensors to a source monitoring seismic control and communication box.

2. The method of claim 1, wherein the source monitoring seismic sensor is positioned at a depth comparable to a depth of the anchoring base from the surface.

3. The method of claim 2, wherein the source monitoring seismic sensor and the anchoring base are separated by a predefined distance.

4. The method of claim 1, wherein the method further comprises:
deploying an array of seismic receivers for recording reflected and refracted seismic waves.

5. The method of claim 4, wherein the method further comprises:
optimizing the vibrator source based on a specific environment to determine ideal sweep setups; and
establishing a sweep schedule to maximize data quality.

6. The method of claim 5, wherein the method further comprises:
creating a baseline seismic model by capturing seismic data over a predetermined timeframe.

7. The method of claim 6, wherein the method further comprises:
acquiring time-lapse seismic data through the array of seismic receivers; and
comparing the time-lapse seismic data against the baseline seismic model to detect variations in seismic attributes.

8. The method of claim 7, wherein the method further comprises:
enabling an identification of structural or physical changes within subsurface formations by analyzing the variations in seismic attributes.

9. The method of claim 1, wherein the source monitoring seismic sensor is mechanically decoupled from the anchoring system.

10. The method of claim 7, wherein the method further comprises:
recording, by the source monitoring seismic sensor, the source sweep waveforms; and
enabling de-ghosting of seismic signals using the source sweep waveforms for improving a resolution of seismic data.

11. The method of claim 10, wherein the method further comprises:
conducting repeated seismic sweeps on a predetermined schedule to generate raw common receiver gathers for each receiver of the array of seismic receivers;
removing source response from individual seismic traces through deconvolution, using corresponding source sweep waveform recorded by the source monitoring seismic sensor;
removing surface ghost reflections from the individual seismic traces through de-ghosting using corresponding seismic data recorded by the one or more de-ghost sensors;
creating a 3D data volume in sweep-offset-time domain by consolidating the deconvolved and de-ghosted common receiver gathers from all receivers;
extracting coherent seismic signals using pattern recognition techniques and filtering out incoherent surface noise;
stacking coherent data from all sweeps to form a shot gather, which serves as a baseline reference for a specific date; and
recording local weather data for the specific date.

12. The method of claim 11, wherein the method further comprises:
consolidating daily shot gathers over a predefined duration to capture seismic response under varying seasonal and weather conditions;
extracting characteristics of surface waves, shallow reflected/refracted waves, and deep reflections below a target layer as functions of date and weather conditions;
processing the characteristics together with the local weather data to form a formation seasonal fingerprint library, wherein the formation seasonal fingerprint library represents a natural seismic response variation in a monitored area under different weather conditions.

13. The method of claim 12, wherein the step of comparing the time-lapse seismic data against the baseline seismic model comprises:
processing current shot gather data from time-lapse seismic surveys to extract its current fingerprint;
comparing the current fingerprint with the formation seasonal fingerprint library to identify a shot gather from a same time period with similar weather conditions; and
using a matched baseline shot gather as a reference to assessing time-lapse changes in the seismic response of a target monitoring layer, ensuring that comparisons account for natural seasonal variations and identifying changes due to subsurface operations.

14. A system for time-lapse seismic data acquisition and processing using highly repeatable seismic surveys, the system comprises:
a vibrator source configured to be mounted to an anchoring system, wherein the vibrator source is configured to generate custom linear or nonlinear sweep signals, the anchoring system comprises an anchoring base;
a source monitoring seismic sensor configured to be installed adjacent to the anchoring base, wherein the source monitoring seismic sensor is configured for recording source sweep waveforms;
one or more de-ghost sensors configured to be mounted on a surface near the vibrator source, wherein the one or more de-ghost sensors are configured to record seismic waveforms at the surface above the source monitoring seismic sensor; and
a source monitoring seismic control and communication box coupling the source monitoring seismic sensor and the one or more de-ghost sensors.

15. A method for time-lapse seismic data acquisition and processing using highly repeatable seismic surveys, the method comprises:
optimizing a seismic source system based on a specific environment to determine ideal sweep setups;
establishing an efficient sweep schedule to maximize data quality;
creating a baseline seismic model by capturing seismic data over a predetermined period; and
continuously acquiring and comparing time-lapse seismic data with the baseline seismic model to detect variations in seismic attributes that reflect structural or physical property changes in subsurface formations.
